(19) United States
(12) Patent Application Publication
(10) Pub. No.: US 2010/0031561 A1
(43) Pub. Date: Feb. 11, 2010

(54) Raceways for Cultivating Algae

(75) Inventors: Patrick G. Hatcher, Norfolk, VA (US); Aron Stubbins, Norfolk, VA (US); Elodie Salmon, Norfolk, VA (US)

Correspondence Address: YOUNG BASILE, 3001 WEST BIG BEAVER ROAD, SUITE 624, TROY, MI, 48084, US

(73) Assignee: OLD DOMINION UNIVERSITY RESEARCH FOUNDATION, Norfolk, VA (US)

(21) Appl. No.: 12/500,837

(22) Filed: Jul. 10, 2009

Related U.S. Application Data
(60) Provisional application No. 61/083,816, filed on Jul. 25, 2008.

(51) Int. Cl. A01G 7/00

(52) U.S. Cl. 47/1.4

(57) ABSTRACT

A raceway for cultivating algae in a liquid medium, comprising one or more precipitators positioned along the raceway, and at which precipitators the algal biomass produced in the raceway is precipitated from the liquid medium and concentrated.

### FIELD OF THE INVENTION

The present invention relates in general to the production of algal biomass, such as may be employed, for instance, in creating biofuels, and, more particularly, to the production of algae in raceways comprising one or more precipitators at which the algal biomass produced is precipitated and concentrated.

### BACKGROUND

The recent emphasis on finding alternative sources to fuel the energy needs of the United States and the world has accelerated the search for replacements for conventional fossil fuels. Producing a liquid fuel from biomass, or biofuel, is an important focus of many alternative energy strategies. Refined vegetable oils have been the typical starting materials for the production of the biofuel commonly known as biodiesel. However, biodiesel can be produced from the oils of many plants, and the biomass derived from algae grown in large scale raceways or in confined bioreactors is receiving a lot of attention as an efficient feedstock for the production of biodiesel.

In practice, the commercial production of algae in open ponds or raceways involves construction of long shallow trenches having maximum exposure to sunlight and containing water such that one achieves optimal growth conditions for algae. Harvesting the algae requires removal of most of the water and eventually substantial drying. This is typically done in a variety of ways. One method involves the attachment of algae to a moving porous belt and removal of the algae by scraping. Another involves a process for water removal in wastewater facilities called dissolved air floatation which floats the algae with fine air bubbles and skims off the surface of the water. Others have proposed centrifugation or filtering of the algae. In all of these technologies, with the exception only of scraping, these harvesting techniques require passing the entire water mass in which the algae grow through the system designed to separate the algae. As such, the energy costs for most conventional harvesting techniques are considerable. It would thus be desirable to find a means for reducing the energy costs that are now considered to be a large fraction of energy expended in the development of biodiesel from algae.

### SUMMARY OF THE DISCLOSURE

The foregoing drawbacks of prior art algae cultivation techniques are addressed by the provision of a raceway for cultivating algae in a liquid medium, the raceway comprising one or more precipitators positioned along the raceway, and at which precipitators algal biomass produced in the raceway is precipitated and concentrated.

According to one feature of the invention, the one or more precipitators are cyclone precipitators. In another aspect of the present invention, two or more cyclone precipitators are provided, the two or more precipitators being positioned successively along the raceway. A first one of the two or more cyclone precipitators occupies a first vertical position, while each successive one of the two or more cyclone precipitators occupies a successively lower vertical position than the first vertical position. Per this feature, the raceway is characterized in that the liquid medium flows downwardly into each precipitator.

Per yet another feature of the present invention, the raceway further comprises means for selectively removing the concentrated algal biomass from each precipitator. In a further aspect, outlet passageways communicating with each of the one or more precipitators are provided, and the means for selectively removing the concentrated algal biomass from each precipitator are positioned between each of the one or more precipitators and each outlet passageway. According to a still further aspect, each of the outlet passageways communicating with each of the one or more precipitators further communicates with a common outlet passageway.

### BRIEF DESCRIPTION OF THE DRAWING

The foregoing and other aspects of the instant invention will be better understood upon reference to the written specification and drawings, of which:

FIG. 1 depicts schematically a segment of a raceway comprising precipitators in accordance with the present invention.

### DETAILED DESCRIPTION

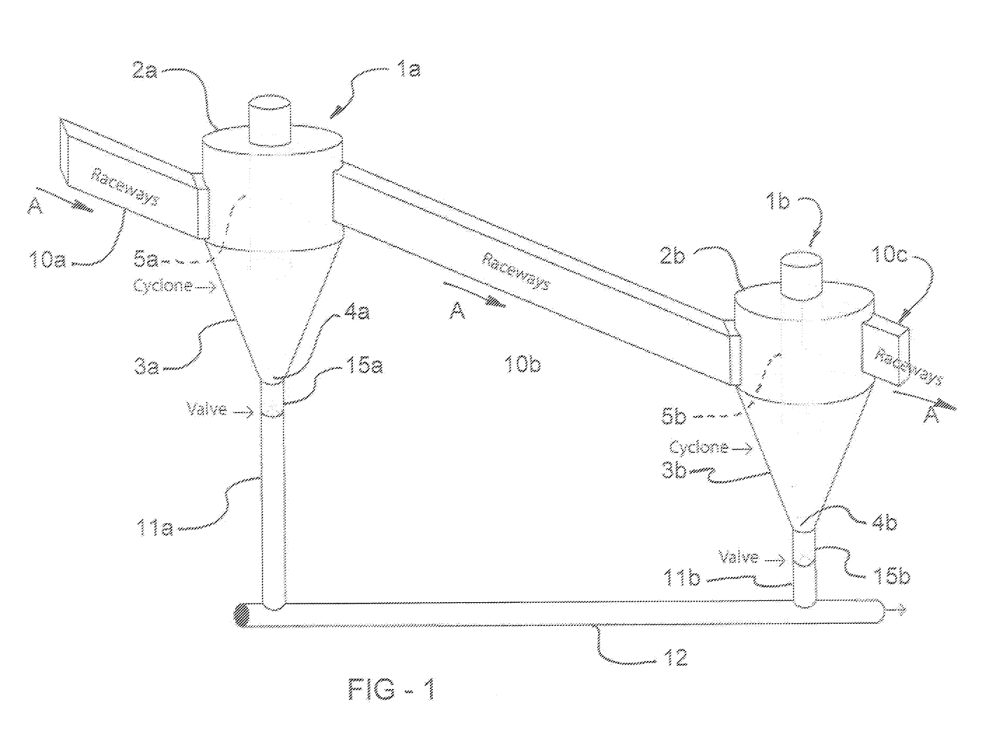

With reference being had also to FIG. 1, wherein like numerals refer to like or corresponding parts, the invention will be seen to most generally comprise a raceway including one or more precipitators 1a, 1b in which algal biomass produced in the raceway is precipitated from the liquid medium and is concentrated. More particularly, the raceway according to the illustrated embodiment will be seen to comprise a number of troughs or chutes 10a, 10b, 10c which primarily define a path through which the liquid medium (e.g., water) moves. According to convention, these troughs or chutes 10a, 10b, 10c are adapted to expose the algae to a suitable light source (e.g., sunlight) to facilitate algal growth. To this end, the troughs/chutes 10a, 10b, 10c may, for example, be open along the top (as depicted), may be fabricated from a material which permits light to pass therethrough, etc.

In the illustrated embodiment of FIG. 1, according to which the raceway comprises at least two precipitators 1a, 1b positioned along the raceway, trough/chute 10a enters the precipitator 1a, through/chute 10c exits the precipitator 1b, while the trough/chute 10b extends between precipitators 1a and 1b. Thus, it will be understood that each precipitator is in fluid communication with adjoining ones of the troughs/chutes 10a, 10b, 10c and so comprises a portion of the overall fluid path of the raceway.

Precipitators 1a, 1b of the illustrated embodiment are cyclone precipitators, each essentially comprising a walled vessel or chamber having an upper cylindrically shaped portion 2a, 2b and, in fluid communication therewith, a lower frusto-conically shaped portion 3a, 3b.

Proximate the lower end of each frusto-conically shaped portion 3a, 3b there is optionally provided an outlet opening 4a, 4b which communicates with an outlet passageway 11a, 11b. Means for selectively removing the precipitated algal biomass from each precipitator, comprising, in the illustrated embodiment, valves 15a, 15b, are positioned between each outlet opening 4a, 4b and its associated outlet passageway 11a, 11b to permit the selective movement of each precipitator's contents into the associated outlet passageway. Operation of valves 15a, 15b, etc. may be manually or automatically controlled.

Each outlet passageway 11a, 11b, etc. is, as shown, connected at an opposite, lower end to a common outlet passageway 12 through which collected algal biomass may be moved to another location for processing.

Each precipitator 1a, 1b according to the illustrated embodiment further comprises an internal passageway 5a, 5b disposed primarily within the cylindrically shaped portion 2a, 2b. Each internal passageway 5a, 5b is open-ended at its bottom. As depicted, the troughs/chutes 10b, 10c exiting each precipitator 1a, 1b, respectively, extend into the interior of the cylindrically-shaped portions 2a, 2b and are connected to the internal passageways 5a, 5b in fluid communication therewith.

Where the invention comprises two or more precipitators, they are positioned successively along the raceway, with a first one of the two or more precipitators occupying a first vertical position, and each successive one of the two or more precipitators occupying a successively lower vertical position than the first vertical position. Further according to the illustrated embodiment, it will be seen that the precipitators 1a, 1b are vertically offset relative to each other, with the upstream precipitator 1a being positioned vertically above the downstream precipitator 1b. Moreover, troughs/chutes 10a, 10b, 10c leading into, between and from the precipitators are sloped downwardly in the direction of liquid flow through the raceway (indicated by arrows A), such that the liquid medium flows downwardly into each one of the two or more precipitators. It will be appreciated that where the raceway defines a closed circuit, means, such as a pump, must be provided at some point in the circuit—such as between the precipitator occupying the lowest vertical position and the precipitator occupying the first, highest vertical position, in order to move the liquid medium from a lower to a higher elevation.

In operation of the invention according to the illustrated embodiment, liquid medium flowing through the raceway and carrying algae enters a precipitator (e.g., 1a) from an upstream trough/chute (e.g., 10a), whereupon a vortex develops as the liquid circulates in the precipitator. Establishment of this vortex drives heavier material in the liquid medium (i.e., the algal biomass) toward the wall of the precipitator and downwardly into the frusto-conically shaped portion (e.g., 3a).

By reason of the pressure of the liquid medium in the precipitator (e.g., 1a), the liquid is forced into the internal passageway (e.g., 5a) and so out through the next adjacent downstream trough/chute (e.g., 10b).

When the amount of algal biomass concentrated in each precipitator is sufficient to warrant harvesting, or at another time as may otherwise be desired, the associated valve (e.g., 15a) is opened and the algal biomass collected in the precipitator (e.g., 1a) is removed from the precipitator into the outlet passageway (e.g., 11a) along with a relatively small amount of the liquid medium (in relation to the total volume of liquid in the raceway as a whole). From there the algal biomass flows through the common outlet passageway 12 (in the direction indicated by the arrow B—which direction will be appreciated to be in consequence of the pressure head established by the successively higher vertical disposition of each precipitator, in the upstream direction of the raceway, relative to the common outlet passageway) to another location for processing.

It will be appreciated that by concentrating the algal biomass through the employment of precipitators positioned along the raceway in the manner of the present invention, the majority of the algae produced throughout the raceway settles in a location near the bottom of each precipitator where it can be can be harvested in relatively small volumes of the liquid medium as compared to the volume of liquid that occupies the entire raceway. The energy costs for harvesting such a relatively small volume of liquid (usually a few percent of the entire mass) are far less than incurred in applying conventional harvesting systems to the entire water mass within the algal raceway system.

While the invention has been described in connection with a certain embodiment, it is to be understood that the invention is not intended to be so limited but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A raceway for cultivating algae in a liquid medium, comprising one or more precipitators positioned along the raceway, and at which precipitators algal biomass produced in the raceway is precipitated from the liquid medium and concentrated.

2. The raceway of claim 1, wherein the one or more precipitators are cyclone precipitators.

3. The raceway of claim 2, wherein two or more cyclone precipitators are positioned successively along the raceway, a first one of said two or more cyclone precipitators occupies a first vertical position, and each successive one of the two or more cyclone precipitators occupies a successively lower vertical position than the first vertical position, and wherein further the raceway is characterized in that the liquid medium flows downwardly into each cyclone precipitator.

4. The raceway of claim 1, further comprising means for selectively removing the concentrated algal biomass from each of the one or more precipitators.

5. The raceway of claim 4, further comprising outlet passageways communicating with each of the one or more precipitators, and wherein the means for selectively removing the concentrated algal biomass from each of the one or more precipitators are positioned between each of the one or more precipitators and each outlet passageway.

6. The raceway of claim 5, wherein each of the outlet passageways communicating with each of the one or more precipitators further communicates with a common outlet passageway.

7. A raceway for cultivating algae in a liquid medium, the raceway comprising a plurality of cyclone precipitators positioned successively along the raceway, at which precipitators algal biomass produced in the raceway is precipitated from the liquid medium and concentrated, wherein a first one of said plurality of cyclone precipitators occupies a first vertical position, and each successive one of the plurality of cyclone precipitators occupies a successively lower vertical position than the first vertical position, and wherein further the raceway is characterized in that the liquid medium flows downwardly into each cyclone precipitator.

8. The raceway of claim 7, further comprising means for selectively removing the concentrated algal biomass from each of the one or more precipitators.

9. The raceway of claim 8, further comprising outlet passageways communicating with each of the one or more precipitators, and wherein the means for selectively removing the concentrated algal biomass from each of the one or more precipitators are positioned between each of the one or more precipitators and each outlet passageway.

10. The raceway of claim 9, wherein each of the outlet passageways communicating with each of the one or more precipitators further communicates with a common outlet passageway.

11. In a raceway for cultivating algae in a liquid medium, the improvement comprising providing one or more precipitators positioned along the raceway, at which precipitators algal biomass produced in the raceway is precipitated from the liquid medium and concentrated.

12. The improved raceway of claim 11, wherein the one or more precipitators are cyclone precipitators.

13. The improved raceway of claim 12, wherein two or more cyclone precipitators are positioned successively along the raceway, a first one of said two or more cyclone precipitators occupying a first vertical position, and each successive one of the two or more cyclone precipitators occupying a successively lower vertical position than the first vertical position, and wherein further the raceway is characterized in that the liquid medium flows downwardly into each precipitator.

14. The improved raceway of claim 13, further comprising means for selectively removing the concentrated algal biomass from each of the one or mote precipitators.

15. The improved raceway of claim 14, further comprising outlet passageways communicating with each of the one or more precipitators, and wherein the means for selectively removing the concentrated algal biomass from each of the one or more precipitators are positioned between each of the one or more precipitators and each outlet passageway.

16. The improved raceway of claim 15, wherein each of the outlet passageways communicating with each of the one or more precipitators further communicates with a common outlet passageway.

17. The improved raceway of claim 11, further comprising means for selectively removing the concentrated algal biomass from each of the one or more precipitators.

18. The improved raceway of claim 17, further comprising outlet passageways communicating with each of the one or more precipitators, and wherein the means for selectively removing the concentrated algal biomass from each of the one or more precipitators are positioned between each of the one or more precipitators and each outlet passageway.

19. The improved raceway of claim 18, wherein each of the outlet passageways communicating with each of the one or more precipitators further communicates with a common outlet passageway.
